(19) United States
(12) Patent Application Publication
(10) Pub. No.: US 2009/0193676 A1
(43) Pub. Date: Aug. 6, 2009

(54) Shoe Drying Apparatus

(76) Inventors: Guo Shengguang, Foshan City (CN); Guo Shengyan, Foshan City (CN)

Correspondence Address: LOUIS VENTRE, JR, 2483 OAKTON HILLS DRIVE, OAKTON, VA, 22124-1530, US

(21) Appl. No.: 12/023,143

(22) Filed: Jan. 31, 2008

(51) Int. Cl. F26B 25/00; F26B 25/06

(52) U.S. Cl. 34/106; 34/202; 34/201; 34/219

(57) ABSTRACT

In the shoe drying apparatus according to the present invention, the ozone-containing air or the mixed air generated and heated by the sanitizing assembly is taken in through intake duct and moves through the main conduit and the auxiliary conduit into the shoe-holding member to sanitize inside of a shoe. After sanitizing, the mixed air moves from inside of the shoe to the interior of the housing, and comes back through return air duct to the anion generator where it is purified and deodorized. The purified air is subsequently sent to a motorized fan contained within the sanitizing assembly. During such circulation, shoes can be sanitized. Moreover, an ultraviolet lamp is installed on the shoe-holding member to sanitize inside of the shoe.

### FIELD OF INVENTION

The present invention relates to a shoe drying apparatus, and more particularly an apparatus in which the ozone-containing air is warmed and blown into shoes though conduits to dry and deodorize as well as sanitize the interior of shoes.

### DESCRIPTION OF PRIOR ART

Shoes easily get dirty and mostly cannot be water washed. If shoes are worn for a long period of time, they are usually under an unsanitary condition, and foot odor, burning, itching and other ailments may result. But this can be recovered to a pleasant and sanitary condition by sanitizing.

In general, shoes are dried and sanitized in the sunlight for the ultraviolet light destroys bacteria. Such natural way is however not appropriate in some occasions, rainy weather for example.

In order to settle these problems, shoe dryer built in with an ozone generator is used. For example, U.S. Pat. No. 6,845,569 discloses a shoe drying apparatus that, while drying shoes, performs sanitizing by distributing to the apparatus the ozone which originates from the ozone generator located in the bottom interior of the apparatus.

But the aforementioned shoe drying apparatus is to be improved. For example, when shoes are dried and sanitized, they are exposed to warm ozone-containing air circulating within the interior of housing. The exposure to high-level ozone causes quality degradation of the outer surface of shoes, leather shoes in particular, for example, less luster and less strength of the leather. Moreover, because of the poor ventilation in the housing, the smell is unpleasant and sometimes spreads over the room, bringing trouble to the user.

It is therefore an object of the present invention to provide a new and improved shoe drying apparatus that warms and distributes ozone-containing air to the inside of shoes through ducts, thereby drying, deodorizing and sanitizing the shoes.

### BRIEF SUMMARY OF THE INVENTION

A shoe drying apparatus according to the present invention comprises: a housing with a hinged door at the front thereof, the interior of the housing becoming airtight when the hinged front door is closed; b) a or a plurality of hollow main conduits being in air communication with intake duct; c) a or a plurality of hollow auxiliary conduits extending from the lateral side of the main conduit along the back wall of the housing, each auxiliary conduit being in air communication with the main conduit; d) a or a plurality of shoe-holding members extending forward and horizontally from auxiliary conduit and being bent downward, at the air opening of the shoe-holding member being mounted a ball valve, and a shoe mold being attached to the shoe-holding member to hold a shoe in place; e) a sanitizing assembly for generating ozone as well as warming and blowing the ozone-containing air to the intake duct connected to the housing for the purpose of sanitizing and drying shoes; f) a return aid duct for dispersing the unprocessed air out of housing; g) an anion generator for removing the odor of the air received from return air duct and then sending the deodorized air into a motorized fan in the sanitizing assembly; and, h) an ultraviolet lamp coated with TiO2, creating photocatalyst during its operation, thereby generating anion which is then discharged into a shoe through small holes to sanitize and deodorize the inner surface of the shoe.

In the shoe drying apparatus according to the present invention, the ozone-containing air or the mixed air generated and heated by the sanitizing assembly is taken in through intake duct and moves through the main conduit and the auxiliary conduit into the shoe-holding member to sanitize inside of a shoe. After sanitizing, the mixed air moves from inside of the shoe to the interior of the housing, and comes back through return air duct to the anion generator where it is purified and deodorized. The purified air is subsequently sent to a motorized fan contained within the sanitizing assembly. During such circulation, shoes can be sanitized. Moreover, an ultraviolet lamp is installed on the shoe-holding member to sanitize inside of the shoe.

In a preferred embodiment, the sanitizing assembly is positioned outside the housing, connected to an intake duct through which the ozone-containing air travels from the assembly to shoe-holding member and a return air duct through which the air moves back to the anion generator and is sent to the motorized fan in the sanitizing assembly after it is purified and deodorized.

In a preferred embodiment, a ball valve having pressure spring on the bottom thereof and pushrod on the top thereof is mounted at the air opening of the shoe-holding member. A shoe mold is attached to the shoe-holding member and moves vertically along it, the upper plate of shoe mold rested on the pushrod of the ball valve and to the bottom plate of shoe mold attached said ultraviolet lamp having circuit contact points on the base thereof. When a shoe is placed on the shoe mold, the ball valve is pressed downward because of the weight of the shoe and the air opening of the shoe-holding member is opened to exhaust mixed air into the shoe. Meanwhile, the circuit contact points are touched to start the ultraviolet lamp for improvement of sanitizing function. When the shoe is removed, the spring acts upward on the ball valve and the shoe mold is pushed back to normal position so that the air opening of the shoe-holding member is blocked and the ultraviolet lamp is stopped.

The shoe drying apparatus according to the present invention can be manufactured in different sizes and of different materials. Moreover, a conventional shoe cabinet without sanitizing function can be transformed into the one in the present invention either by installing sanitizing assembly and anion generator outside the housing or by installing the sanitizing assembly inside the housing.

### BRIEF DESCRIPTION OF THE DRAWINGS

For a further understanding of the present invention, reference should be had to the following description taken in conjunction with the accompanying drawings in which:

FIG. 1 is a perspective view of a shoe drying apparatus according to an embodiment of the present invention.

FIG. 2 is a perspective view of housing of the shoe drying apparatus.

FIG. 3 is a perspective view of shoe-holding member of the shoe drying apparatus.

### DETAILED DESCRIPTION

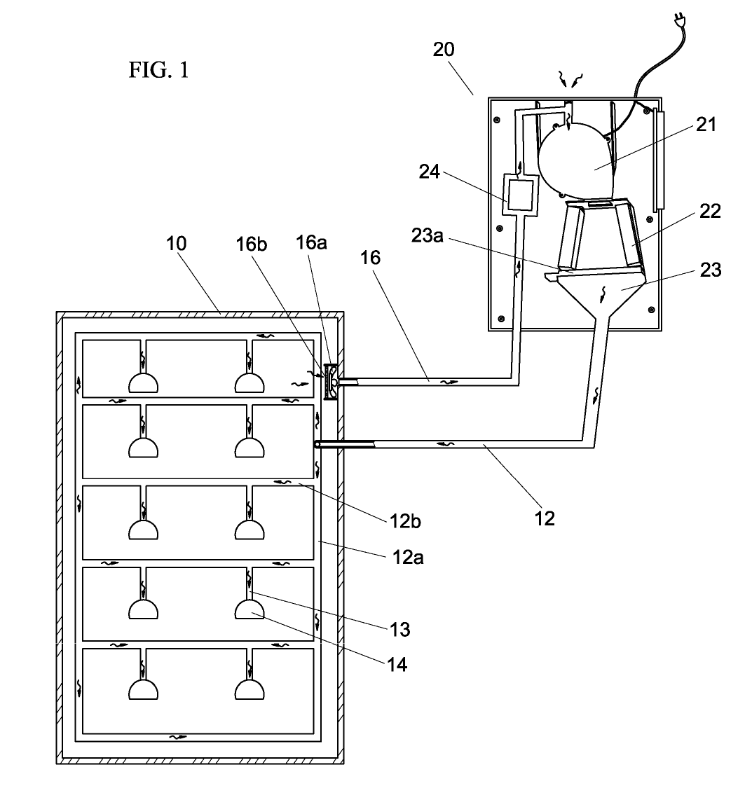

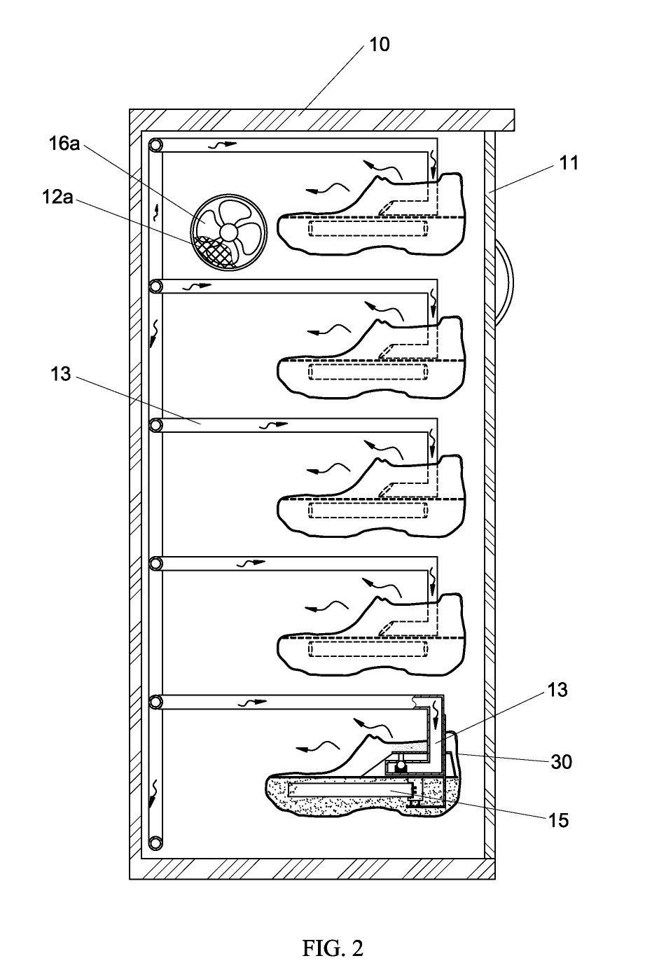

A shoe drying apparatus according to a preferred embodiment of the present invention is illustrated in FIGS. 1-2. A shoe drying apparatus is composed of a housing 10 having a hinged door 11 at the front thereof, the interior of housing 10 becoming airtight when the hinged door 11 is closed, thus preventing the unpleasant smell from leaking out and minimizing the heat loss of the airflow in the housing.

Referring to FIG. 1, near the side wall of the housing 10 is positioned vertically the main conduit 12a sealed to intake duct 12 and extending out of the housing 10. From the lateral side of main conduit 12a extend a plurality of auxiliary conduits 12b along the back wall of the housing 10. From each auxiliary conduit 12b extends horizontally and forward a shoe-holding member 13, the end thereof bent downward in the shape of hook to fix a shoe thereto. The shoe-holding member 13 is in air communication with the main conduit 12a and auxiliary conduit 12b. The air taken in from the intake duct 12 passes through the main conduits 12a, the auxiliary conduit 12b, and the shoe-holding member 13 respectively, and is introduced into the shoe 30 from the air opening of the shoe-holding member 13.

Referring again to FIG. 1, the preferred embodiment also includes a sanitizing assembly 20 to generate ozone as well as to warm and discharge the ozone-containing air into housing 10 through the intake duct 12. The sanitizing assembly 20 is composed of a motorized fan 21, an ozone generator 22 and a heating device 23. The motorized fan collects ambient room air through air inlet and forces it into the sanitizing assembly 20 where the room air is mixed with ozone created by ozone generator 22. The ozone-containing air is blown by the motorized fan to a heating device 23 where it is warmed for the purpose of better sanitizing and drying shoes 30. The warmed air is then forced into the intake duct 12.

A heating device is composed of a heater plate 23a and a timer (not shown). A control circuit (not shown) is connected to the heater plate 23a through the timer, the control circuit and timer together serving to control the operation time of heater plate 23a. The heating device 23 further contains an overheat protector (not shown).

Between the ozone generator 22 and the control circuit (not shown) is located an ozone switch (not shown), which can turn off ozone generator 22 while the heating device 23 is operating so that only drying of shoes is performed.

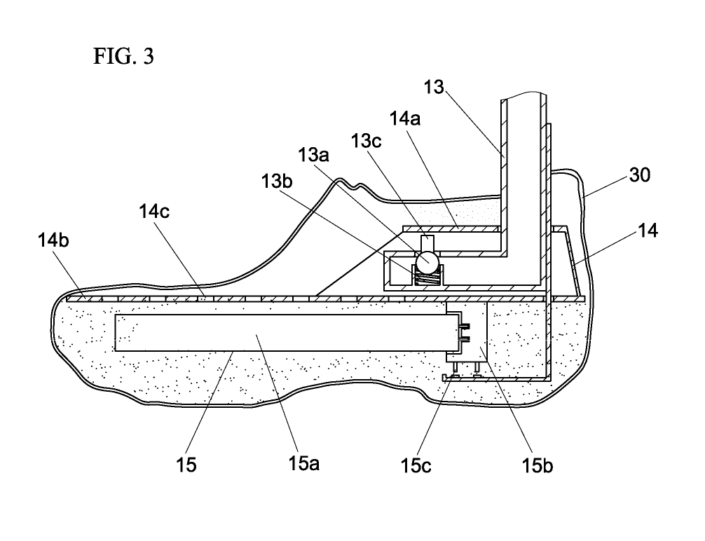

Referring to FIG. 3, a ball valve 13a having pressure spring 13b on the bottom thereof and pushrod 13c on the top thereof is mounted at the air opening of the shoe-holding member 13. The spring 13b can push the ball valve 13a upward to block the air opening of the shoe-holding member 13. A shoe mold 14 is detachably attached to the end of the shoe-holding member 13 for holding a shoe 30 in place and can move vertically along the shoe-holding member 13.

The upper plate 14a of shoe mold 14 is rested on the pushrod 13c of the ball valve 13a and to the bottom plate 14b of the shoe mold 14 is attached an ultraviolet lamp 15 for sterilizing the shoe 30. The ultraviolet lamp 15 comprises a tube 15a and a base 15b between which there are circuit contact points. When a shoe 30 is placed on, the shoe mold 14 presses downward the pushrod 13c and the spring 13b because of the weight of the shoe, opening the ball valve 13a and allowing the mixed air to move into the interior of shoe 30 for sanitizing through air opening of the shoe-holding member 13. Meanwhile, the circuit contact points 15c on the lamp base 15a are touched to start the ultraviolet lamp 15 for sanitizing. When the shoe 30 is removed from the shoe mold 14 after sanitizing, the ball valve 13a and spring 13b are released, thereby blocking the air opening of the shoe-holding member 13, and the circuit contact points 15c on the lamp base 15a are separated, thereby turning off the ultraviolet lamp 15.

The ultraviolet lamp 15 is coated with TiO2 which can create photocatalyst in the presence of light to remove odor, bacteria and contaminant. During the operation of the ultraviolet lamp 15, photocatalyst generates anion air which is subsequently discharged inside the shoe for deodorizing and sterilizing through small holes 14c on the bottom plate 14b of the shoe mold 14.

The mixed air originating from sanitizing assembly 20 passes through intake duct 12 on its way to shoe-holding member 13 and is discharged from the air opening thereof into the shoe 30 for sterilizing. After the performance, the concentration of ozone is reduced and the air containing low-level ozone moves from inside the shoe 30 to the interior of the housing 10. When the door 11 is closed, air pressure in the airtight housing 10 is increased leading to a failure of the apparatus to function normally. To settle this problem, return air duct 16 is installed on the side wall of housing 10 to discharge the unprocessed air out so that the air pressure is balanced both inside and outside the housing 10. Return air duct 16 is sealed to the side wall of housing 10 to avoid leakage of air. At the inlet of return air duct 16 is positioned an exhaust fan 16a which forces the unprocessed air out of the housing 10 through return air duct 16. In front of the exhaust fan 16a is located a filter screen 16b to keep out particles from entering the return air duct 16 with airflow.

Referring to FIG. 1, the shoe drying apparatus also comprise an anion generator 24 for deodorizing. The unprocessed air from housing 10 passes through return air duct 16 and the anion generator 24 where it is deodorized and becomes fresh on its way to the motorized fan 21 for repeated circulation.

The present invention has been described in detail with reference to a preferred embodiment. Besides the said embodiment, all suitable equivalents may be resorted to, falling within the scope of the invention.

What is claimed is:

1. A shoe drying apparatus comprising:
(a) a housing with a hinged door at the front thereof, the interior of said housing becoming airtight when said hinged door is closed;
(b) a main conduit being in air communication with intake duct;
(c) an auxiliary conduit extending from the lateral side of said main conduit along back wall of said housing, said auxiliary conduit being in air communication with said main conduit;
(d) a shoe-holding member to hold a shoe in place;
(e) a sanitizing assembly for generating and warming the ozone-containing air as well as blowing such air into said housing through intake duct to sanitize and dry the inner surface of shoe;
(f) a return air duct for discharging unprocessed air out of said housing;
(g) an anion generator for eliminating the odor of the air received from said return air duct and sending the deodorized air into a motorized fan in sanitizing assembly; and,
(h) an ultraviolet lamp to destroy bacteria in the shoe.

2. The shoe drying apparatus according to claim 1, wherein a sanitizing assembly comprises a motorized fan, an ozone generator and a heating device for generating and warming ozone-containing air and sending the air to said housing to sanitize and dry shoes through intake duct.

3. The shoe drying apparatus according to claim 2, wherein the apparatus further includes a control circuit.

4. The shoe drying apparatus according to claim 2, wherein an ozone switch is positioned between said control circuit and said ozone generator.

5. The shoe drying apparatus according to claim 2, wherein said heating device comprises a heater plate and a timer.

6. The shoe drying apparatus according to claim 1, wherein said shoe-holding member extends forward and horizontally from said auxiliary conduit and is bent downward.

7. The shoe drying apparatus according to claim 1, wherein a ball valve is installed at the air opening of said shoe-holding member.

8. The shoe drying apparatus according to claim 1, wherein a shoe mold is mounted onto said shoe-holding member.

9. The shoe drying apparatus according to claim 8, wherein the bottom plate of the shoe mold has small holes therein.

10. The shoe drying apparatus according to claim 1, wherein the ultraviolet lamp is coated with TiO2 which creates photocatalyst during the operation of said lamp, thereby generating anion for sanitizing and deodorizing the shoes.

11. The shoe drying apparatus according to claim 1, wherein a fan is positioned at the inlet of said return air duct.

12. The shoe drying apparatus according to claim 11, wherein a filter screen is positioned in front of said fan.
